(19) United States
(12) Patent Application Publication
(10) Pub. No.: US 2005/0043028 A1
(43) Pub. Date: Feb. 24, 2005

(54) Arrangement for supporting data exchange between terminal equipment and a mobile communication network via a mobile terminal

(75) Inventor: Arto Suomi, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/645,866

(22) Filed: Aug. 20, 2003

(51) Int. Cl. H04Q 7/20

(52) U.S. Cl. 455/435.1; 455/466

(57) ABSTRACT

The invention relates to a method for supporting a data exchange between terminal equipment and a mobile communication network via a mobile terminal. The method comprises at the mobile terminal receiving from the terminal equipment a request to establish a connection to the mobile communication network for exchanging data and forwarding this request to the mobile communication network. The method further comprises in case a failure occurs concerning the requested connection and an indication of a cause of the failure is received at the mobile terminal from the mobile communication network, forwarding the indication to the terminal equipment. The invention relates equally to a corresponding mobile terminal, to a corresponding terminal equipment, to a corresponding system and to a corresponding software program product.

### FIELD OF THE INVENTION

The invention relates to a method for supporting a data exchange between terminal equipment and a mobile communication network via a mobile terminal. The invention relates equally to a corresponding mobile terminal, to a corresponding terminal equipment, to a corresponding system and to a corresponding software program product.

### BACKGROUND OF THE INVENTION

It is known in the art to enable terminal equipment, which is not capable of directly accessing a mobile communication network itself, to access such a mobile communication network via a mobile terminal.

The technical specification 3GPP TS 27.060 V5.4.0 (2003-06): “Technical Specification Group Core Network; Packet Domain; Mobile Station (MS) supporting Packet Switched Services” defines for example requirements for an interworking between terminal equipment and a mobile terminal for the Packet Domain, including the protocols and signaling needed to support Packet Switched services.

When a mobile terminal tries to establish a connection to a mobile communication network upon a request by terminal equipment, the setup may fail due to various reasons, for example due to insufficient network resources. Equally, an already established connection may be released from the network side prematurely due to various reasons, for example due to an error situation in the mobile communication network. The failure does not necessarily have to be in the mobile communication network itself, but may also be reported to the mobile communication network, for instance by an external network, which the mobile terminal tries to access via the mobile communication network.

When a mobile communication network rejects a request for an establishment of a connection or releases an established connection, it usually informs the mobile terminal about the respective cause of the failure. The technical specification 3GPP TS 24.008 V6.1.0 (2003-06): “Technical Specification Group Core Network; Mobile radio interface Layer 3 specification; Core network protocols; Stage 3”, for instance, associates to this end GPRS specific cause values for a session management to various failure causes. A cause value which is transmitted by a mobile communication network to a mobile terminal may cause a corresponding textual error message to be displayed on a user interface of the mobile terminal.

There is no mechanism, however, to inform as well terminal equipment trying to access the mobile communication network via the mobile terminal why a requested connection is not established or why an established connection is released. This is a disadvantage, since users using their terminal equipment do usually not look in parallel at their mobile terminal.

### SUMMARY OF THE INVENTION

The invention facilitates the establishment and maintenance of a connection between terminal equipment and a mobile communication network via a mobile terminal.

A method for supporting a data exchange between terminal equipment and a mobile communication network via a mobile terminal is proposed, which comprises at the mobile terminal receiving from the terminal equipment a request to establish a connection to the mobile communication network for exchanging data and forwarding the request to the mobile communication network. The method further comprises in case a failure occurs concerning the requested connection and an indication of a cause of the failure is received at the mobile terminal from the mobile communication network, forwarding the indication to the terminal equipment.

Moreover, a mobile terminal is proposed which comprises a transceiver enabling an exchange of signals with a mobile communication network and in addition an interface enabling an exchange of signals with other devices. The proposed mobile terminal further comprises a processing component for receiving from terminal equipment via the interface a request to establish a connection to a mobile communication network for exchanging data, for forwarding the request to a mobile communication network via the transceiver, and in case a failure occurs concerning the connection and an indication of a cause of the failure is received from the mobile communication network, for forwarding the indication to the terminal equipment.

Moreover, terminal equipment is proposed which comprises an interface enabling an exchange of signals with other devices. The proposed terminal equipment further comprises a processing component for requesting a mobile terminal via the interface to establish a connection to a mobile communication network, for receiving from a mobile terminal an indication of a cause of a failure concerning a requested connection and for processing a received indication of a cause of a failure.

Moreover, a system is proposed which comprises the proposed mobile terminal, the proposed terminal equipment and a mobile communication network.

Finally, a software program product is proposed, in which a software code for supporting a data exchange between terminal equipment and a mobile communication network via a mobile terminal is stored. The software code realizes the following steps when running in a processing component of a mobile terminal: Receiving from a mobile communication network an indication of a cause of a failure concerning a connection which has been requested by terminal equipment via the mobile terminal and forwarding the indication to the terminal equipment.

The invention proceeds from the idea that an indication of the cause of a failure provided by a mobile communication network to a mobile terminal can be forwarded by the mobile terminal to a terminal equipment, if the failure relates to a connection between the mobile terminal and the mobile communication network requested by the terminal equipment.

It is an advantage of the invention that information on the cause of a failure concerning a connection which has been requested by the terminal equipment is available as well at the terminal equipment. The terminal equipment may make use of the received information for example by displaying it to a user via a user interface of the terminal equipment or by storing it for a later evaluation.

The failure for which a cause is provided may be a failure resulting in a rejection of the request to establish a connection, i.e. the failure may occur before the connection is actually established. Alternatively, the failure for which a cause is provided may be a failure resulting while a connection is established.

For the connection between the terminal equipment and the mobile terminal, for instance the Point-to-Point Protocol (PPP) can be used. PPP provides a standard method for transporting multi-protocol datagrams over point-to-point links.

If the connection between the terminal equipment and the mobile terminal is PPP-based, the indication of a failure cause can be forwarded to the terminal equipment in particular in the data field of an Link Control Protocol (LCP) Terminate Request message described in the IETF RFC 1661 “The Point-to-Point Protocol (PPP)” by W. Simpson, (Editor), July 1994.

PPP is comprised of three main components, a method for encapsulating multi-protocol datagrams, an LCP for establishing, configuring, and testing the data-link connection and a family of Network Control Protocols (NCPs) for establishing and configuring different network-layer protocols.

The IETF RFC 1661 defines three classes of LCP packets, namely Link Configuration packets used to establish and configure a link, Link Termination packets used to terminate a link and Link Maintenance packets used to manage and debug a link. Each of these packets comprises a code field, an identifier field, a length field and a data field of zero or more octets. The format of the data field is determined by the code field, and the length of the data field is indicated in the length field. While the content of the data field is defined for Link Configuration packets and Link Maintenance packets, it may contain any data for use by the sender in the case of Link Termination packets. This data may consist of any binary value and is thus suited to comprise as well cause values provided by a mobile communication network.

The invention can be employed for example with a GPRS capable mobile terminal, but equally with any other mobile terminal which enables terminal equipment to access a mobile communication network. The invention can further be employed for any terminal equipment which is able to establish a connection to a mobile communication network via a mobile terminal, for example a PDA or a PC.

The invention can be realized in particular, though not exclusively, by a software running in the processing component of the mobile terminal and of the terminal equipment, respectively.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 schematically shows a system in which the invention can be implemented;

FIG. 2 is a flow chart illustrating an embodiment of the method according to the invention;

FIG. 3 is a diagram illustrating some signaling in the embodiment of the method according to the invention; and

FIG. 4 illustrates an LPC Terminate Request message format employed in the embodiment of the method according to the invention.

### DETAILED DESCRIPTION OF THE INVENTION

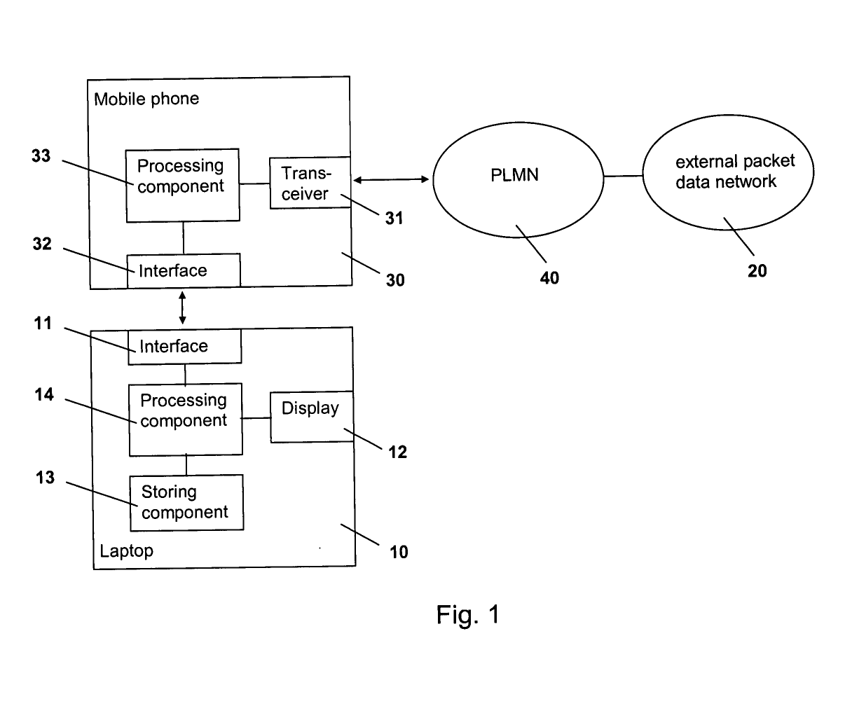

The invention can be implemented for example in the system depicted in FIG. 1. In this system, a terminal equipment 10 may access an external packet data network 20 via a mobile terminal 30 and a mobile communication network 40.

The terminal equipment 10 of the system is assumed by way of example to be a laptop computer. The laptop computer 10 comprises an external interface 11, a display 12 as a user interface, a storing component 13 and a processing component 14. The processing component 14 is connected to each of the external interface 11, the display 12 and the storing component 13. The processing component 14 is designed specifically for realizing the invention, as will become apparent further below. It is to be understood that also the processing component 14 can be composed of one or of several components, that it may comprise software and/or hardware elements for the required processing, and that it can be connected to the external interface 11, the display 12 and the storing component 13 either directly or via further components. The laptop computer 10 comprises in addition various other components as known in the art, which are not shown in FIG. 1.

The mobile terminal 30 of the system is assumed by way of example to be a GPRS capable mobile phone. The mobile phone 30 comprises a transceiver 31, an external interface 32 and a processing component 33 connected to both. The processing component 33 is designed specifically for realizing the invention, as will become apparent further below. It is to be understood that the processing component 33 can be composed of one or of several components, that it may comprise software and/or hardware elements for the required processing, and that it can be connected to the transceiver 31 and to the external interface 32 either directly or via further components. The mobile phone 30 comprises in addition various other components as known in the art, which are not shown in FIG. 1.

The mobile communication network 40 of the system is assumed by way of example to be a PLMN (Public Land Mobile Network) enabling communication in a packet switched network, e.g., GPRS. The mobile communication network 40 provides access to the external packet data network 20 in a known manner. The access to the external packet data network 20 can be used for example to request packet data for a specific service which is offered via the external packet data network 20.

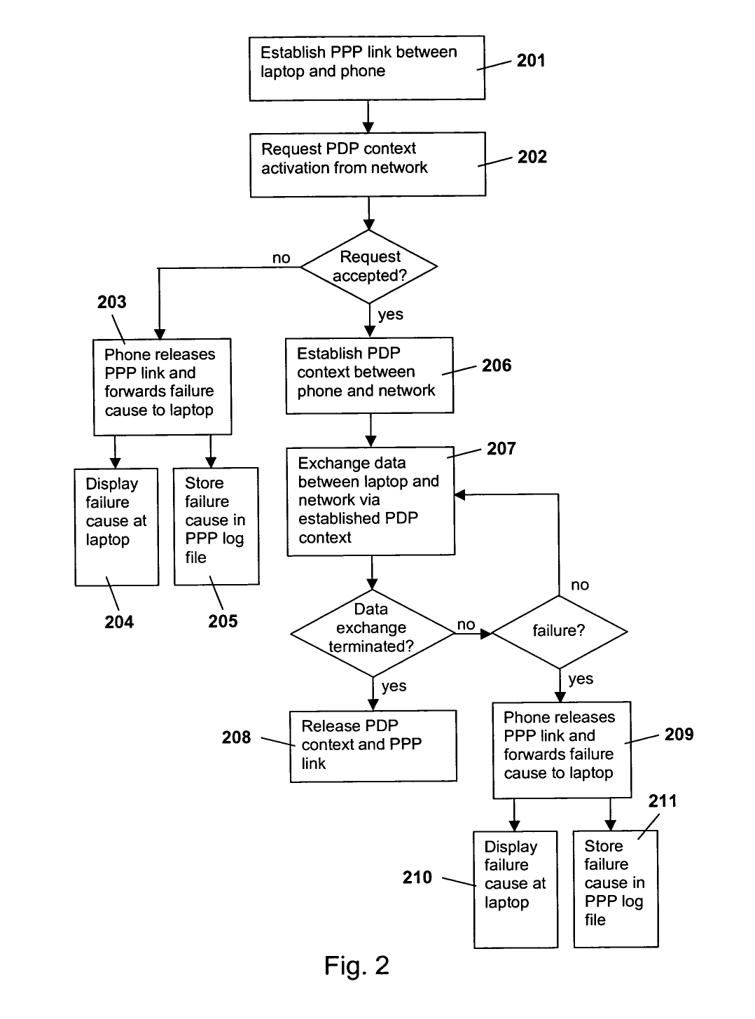

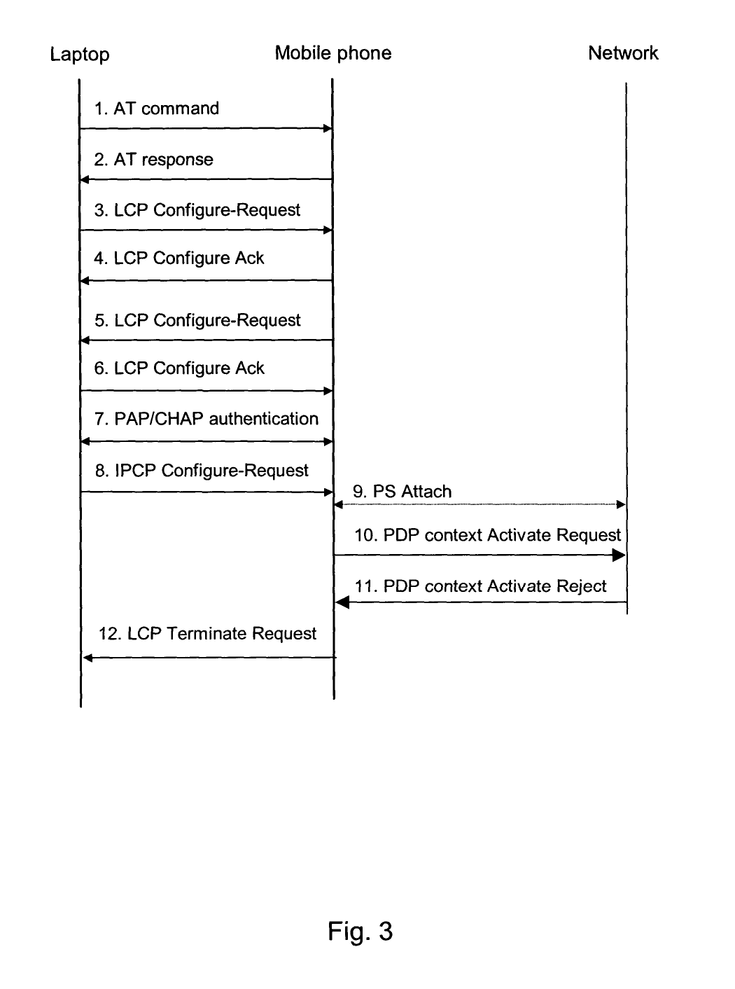

The functioning of the system of FIG. 1 will now be explained in more detail with reference to FIGS. 2 and 3. FIG. 2 is a flow chart schematically illustrating the method according to the invention on the mobile side, i.e. on the side of the laptop computer 10 and the mobile phone 30. FIG. 3 is a modified diagram from the above mentioned specification TS 27.060, which is incorporated by reference herein. The diagram of FIG. 3 illustrates the signaling between the laptop computer 10, the mobile phone 30 and the mobile communication network 40 for a part of the flow chart of FIG. 2. All signaling between the laptop computer 10 and the mobile phone 30 is carried out via the interfaces 11, 32, and the mobile phone 30 exchanges signals with the mobile communication network 40 via its transceiver 31.

When a user of the laptop computer 10 desires to access the external packet data network 20, first a PPP link has to be established between the laptop computer 10 and the mobile phone 30, which is represented in FIG. 2 by a first block 201.

The signaling between the laptop computer 10 and the mobile phone 30 for establishing the PPP link is shown in more detail as steps 1 to 7 in FIG. 3.

In step 1, the processing component 14 of the laptop computer 10 sends an AT command message to the processing component 33 of the mobile phone 30 in order to set up parameters and to enter a PPP mode. The processing component 33 of the mobile phone 30 responds with an AT response message in step 2. For establishing the PPP link between the laptop computer 10 and the mobile phone 30, a PPP in the processing component 14 of the laptop computer 10 then sends an LCP Configure-Request message to the processing component 33 of the mobile phone 30 in step 3. In step 4, the processing component 33 of the mobile phone 30 returns an LCP Configure-Ack message to the processing component 14 of the laptop computer 10 to confirm that the PPP link has been established.

Further, a PPP in the processing component 33 of the mobile phone 30 sends an LCP Configure-Request message to the processing component 14 of the laptop computer 10 in step 5 to negotiate for the authentication protocol which is to be used for authenticating the laptop computer 10 towards the mobile phone 30. The processing component 14 of the laptop computer 10 returns thereupon in step 6 an LCP Configure-Ack message to the processing component 33 of the mobile phone 30 to confirm the use of the specified authentication protocol. If the negotiated authentication protocol is either CHAP (Challenge Handshake Authentication Protocol) or PAP (Password Authentication Protocol), the laptop computer 10 authenticates itself towards the mobile phone 30 by means of this protocol in step 7.

Once the PPP link is established, a PDP (Packet Data Protocol) context has to be activated between the mobile phone 30 and the mobile communication network 40, which is represented in FIG. 2 by block 202.

The signaling between the laptop computer 10, the mobile phone 30 and the mobile communication network 40 for the activation of the PDP context is shown as steps 8 to 10 in FIG. 3.

In step 8, the PPP in the processing component 14 of the laptop computer 10 sends an IPCP (Internet Protocol Control Protocol) Configure-Request message to the processing component 33 of the mobile phone 30 for activating the IP protocol. The IPCP constitutes a selected NCP (Network Control Protocol). This message comprises the request to establish a PDP context and all information on the service desired by the laptop computer, for example a PDP address for the desired service and user authentication information for the desired service. If the mobile phone 30 is not yet PS (Packet Switched) attached to the mobile communication network 40, the processing component 33 of the mobile phone 30 initiates thereupon in step 9 a PS attach procedure with the mobile communication network 40. In step 10, the processing component 33 of the mobile phone 30 transmits a PDP Context Activation Request message to the mobile communication network 40.

In case the external packet data network 20 or the mobile communication network 40 does not accept for some reason the request to establish a PDP context, the PPP link between the laptop computer 10 and the mobile phone 30 is released again, which is represented in FIG. 2 by block 203. In accordance with the invention, the cause for the release is indicated to the laptop computer 10.

The signaling between the laptop computer 10, the mobile phone 30 and the mobile communication network 40 for the rejection of the PDP context and the release of the PPP link is shown as steps 11 and 12 in FIG. 3.

In step 11, the mobile communication network 40 rejects the PDP context activation request by transmitting a PDP context Activate Reject message to the processing component 33 of the mobile phone 30. The rejection message contains an eight-bit cause value indicating the reason for the failure. The cause value and its association to a specific failure cause is taken from the above mentioned specification TS 24.008. In this specification it is proposed, for example, that a mobile communication network informs a mobile terminal that a request cannot be accepted due to insufficient resources with a cause value of 26 or that a requested service was rejected by an external packet data network because a PDP address or type could not be recognized with a cause value of 28. Similarly, other cause values are defined for various other failure causes.

In step 12, the processing component 33 of the mobile phone 30 sends an LCP Terminate Request message to the processing component 14 of the laptop computer 10 which contains the same cause value as the PDP context Activate Reject message received by the mobile phone 30.

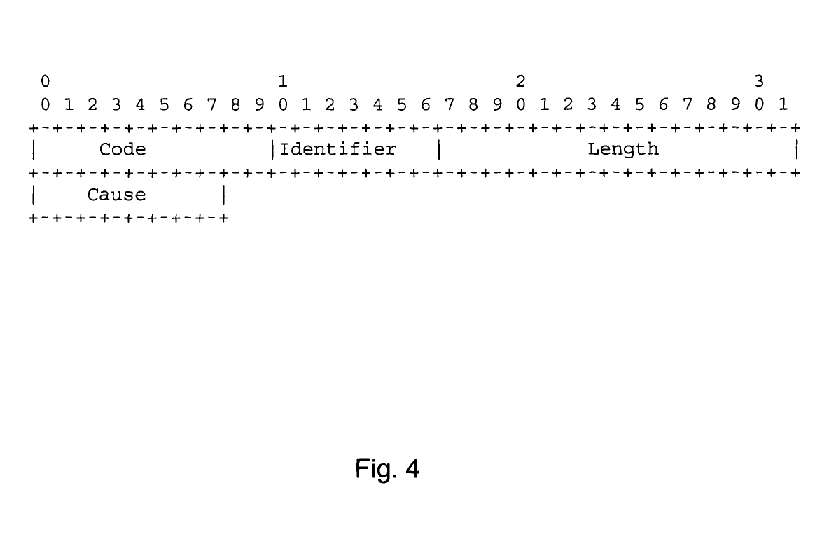

The structure of the employed LCP Terminate Request message is presented in FIG. 4.

The LCP Terminate Request message comprises a Code-field of 10 bits, an Identifier-field of 7 bits, a Length-field of 15 bits, and a Cause-field of 8 bits. The structure of the LCP Terminate Request message thus corresponds to the structure of the LCP Terminate Request message defined in the above mentioned RFC 1661, except that the Data-field is defined as Cause-field. The value in the Code-field is set to “5”, as defined in the RFC 1661 for a Terminate Request message. The value in the Identifier-field is set component 14 of the laptop computer 10 in a PPP log file in the storing component 13. Thus, also the LCP Terminate Request message comprising the cause value is stored in the PPP log file, as represented in FIG. 2 by block 205.

In case the external packet data network 20 and the mobile communication network 40 accept the PDP context Activate Request represented by block 202 in FIG. 2, the PDP context is established between\rtl\i\e mobi\l\Fp\hbne 30 and the mobile communication network 40, as represented by block 206 in FIG. 2. The processing component 33 of the mobile phone 30 informs the laptop computer 10 that the IP protocol is activated by sending an IPCP Configure-Ack message to the processing component 14 of the laptop computer 10. Now, the packet data of a desired service may be delivered by the external packet data network 20 via the mobile communication network 40 to the mobile phone 30 using the established PDP context and further to the laptop computer 10 using the PPP link in a known manner. This is indicated in FIG. 2 by block 207.

When all packet data belonging to the desired service has been transmitted successfully, the PDP context and the PPP link are released again in a known manner. This is indicated in FIG. 2 by block 208.

If, however, there is some failure during the transmission of the packet data, the established PDP context is released by the mobile communication network 40 and the processing component 33 of the mobile phone 30 is informed about the cause of the failure in a known manner with a cause value as defined in the above mentioned specification TS 24.008. The processing component 33 of the mobile phone 30 releases thereupon as well the PPP link to the laptop computer 10 by transmitting an LCP Terminate Request message to the laptop computer 10, as indicated in FIG. 2 by block 209. The LCP Terminate Request message has again the structure depicted in FIG. 4 and comprises in the Cause-field the cause value provided by the mobile communication network 40.

As in the case of an initial failure, the processing component 14 of the laptop computer 10 extracts the cause value from the received LCP Terminate Request message, retrieves an associated textual error message from the storing component 13 and presents the retrieved textual error message on the display 12 of the laptop computer 10, as represented in FIG. 2 by block 210. Further, the LCP Terminate Request message comprising the cause value is stored in the PPP log file, as represented in FIG. 2 by block 211.

The user of the laptop computer 10 is thus informed directly via the display 12 of the laptop computer 10 about any failure causes. This has the advantage that the user has only to keep an eye on the laptop computer 10 for being informed comprehensively and for being able to react accordingly. Based on the cause values stored in the PPP log files of the laptop computer 10, the failure reason can also be debugged at a later point of time.

While it has been shown, described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for supporting a data exchange between terminal equipment and a mobile communication network via a mobile terminal, said method comprising at said mobile terminal:
receiving from said terminal equipment a request to establish a connection to said mobile communication network for exchanging data;
forwarding said request to said mobile communication network; and
in case a failure occurs concerning said requested connection and an indication of a cause of said failure is received from said mobile communication network, forwarding said indication to said terminal equipment.

2. The method according to claim 1, wherein said failure is a failure resulting in a rejection of said request to said mobile communication network to establish a connection, said indication being an indication of a cause of said rejection.

3. The method according to claim 1, wherein said failure is a failure resulting in a release of a connection established between said mobile terminal and said mobile communication network upon said request to establish a connection, said indication being an indication of a cause of said release.

4. The method according to claim 1, further comprising at said terminal equipment receiving said indication of a cause of a failure from said mobile terminal and presenting a corresponding information to a user of said terminal equipment.

5. The method according to claim 1, further comprising at said terminal equipment receiving said indication of a cause of a failure from said mobile terminal and storing said indication for further use.

6. The method according to claim 1, wherein said terminal equipment is connected to said mobile terminal by a point-to-point protocol connection and wherein said mobile terminal forwards said indication of a cause of a failure in a data field of a link control protocol packet.

7. A mobile terminal comprising:
a transceiver enabling an exchange of signals with a mobile communication network;
an interface enabling an exchange of signals with other devices; and
a processing component for receiving from terminal equipment via said interface a request to establish a connection to a mobile communication network for exchanging data, for forwarding said request to a mobile communication network via said transceiver, and in case a failure occurs concerning said connection and an indication of a cause of said failure is received from said mobile communication network, for forwarding said indication to said terminal equipment.

8. Terminal equipment comprising:
an interface enabling an exchange of signals with other devices; and
a processing component for requesting a mobile terminal via said interface to establish a connection to a mobile communication network, for receiving from a mobile terminal an indication of a cause of a failure concerning a requested connection and for processing a received indication of a cause of a failure.

9. Terminal equipment according to claim 8, further comprising a user interface, wherein said processing component is enabled to process a received indication of a cause of a failure by presenting a corresponding information to a user via said user interface.

10. Terminal equipment according to claim 8, further comprising a storing component, wherein said processing component is enabled to process a received indication of a cause of a failure by storing said received indication in said storing component for a later evaluation.

11. A system comprising a mobile communication network, a mobile terminal and terminal equipment,
said mobile terminal including:
a transceiver enabling an exchange of signals with said mobile communication network;
an interface enabling an exchange of signals with said terminal equipment; and
a processing component for receiving from terminal equipment via said interface a request to establish a connection to a mobile communication network for exchanging data, for forwarding said request to a mobile communication network via said transceiver, and in case a failure occurs concerning said connection and an indication of a cause of said failure is received from said mobile communication network, for forwarding said indication to said terminal equipment, and
said terminal equipment including:
an interface enabling an exchange of signals with said mobile terminal; and
a processing component for requesting a mobile terminal via said interface to establish a connection to a mobile communication network, for receiving from a mobile terminal an indication of a cause of a failure concerning a requested connection and for processing a received indication of a cause of a failure.

12. A software program product in which a software code for supporting a data exchange between terminal equipment and a mobile communication network via a mobile terminal is stored, said software code realizing the following steps when running in a processing component of a mobile terminal:
receiving from a mobile communication network an indication of a cause of a failure concerning a connection which has been requested by terminal equipment via said mobile terminal; and
forwarding said indication to said terminal equipment.
